(19) United States
(12) Patent Application Publication
(10) Pub. No.: US 2003/0076424 A1
(43) Pub. Date: Apr. 24, 2003

(54) Digital camera

(76) Inventors: Jun Minakuti, Sakai-Shi (JP); Hiroshi Ueda, Habikino-Shi (JP); Motoshi Yamaguchi, Sakai-Shi (JP); Tougo Teramoto, Wakayama-Shi (JP); Masahito Niikawa, Sakai-Shi (JP)

Correspondence Address: SIDLEY AUSTIN BROWN & WOOD LLP, 717 NORTH HARWOOD, SUITE 3400, DALLAS, TX, 75201, US

(21) Appl. No.: 10/270,759

(22) Filed: Oct. 15, 2002

(30) Foreign Application Priority Data
Oct. 18, 2001 (JP) P2001-320393

(51) Int. Cl. H04N 5/225

(52) U.S. Cl. 348/223.1

(57) ABSTRACT

An image processing system has a digital camera and a colorimeter, and radio data communications can be performed between the digital camera and the colorimeter. The colorimeter obtains a color component value in the direction of a subject and transmits the value to the digital camera. The color component value received by the digital camera is stored in an internal RAM. When the color component value is stored in the RAM at the time of image capturing, the digital camera performs white balance correction on captured image data on the basis of the color component value. Thus, white balance correction can be performed on the image data with high precision.

This application is based on application No. 2001-320393 filed in Japan, the contents of which are hereby incorporated by reference.

### BACKGROUND OF THE INVENTION

1. Field of the Invention

The present invention relates to a color correcting technique using a portable colorimeter.

2. Description of the Background Art

In image data captured by an image capturing apparatus such as a camera using a film or a digital camera, due to an influence of illumination light for illuminating a subject, a phenomenon that shooting provides a cast of colors according to light source (so-called an overall color cast or color fog) occurs. For a human being having color constancy, due to the phenomenon, image data looks unnatural, so that correction for the phenomenon (white balance correction) has been performed conventionally.

As one of the correcting methods, a portable colorimeter for detecting color component values such as chromaticity and color temperature of incident light with high precision has been used. Concretely, a color component value in the direction of a subject is detected by a colorimeter, according to the detected color component value, a filter for correcting colors is attached to the lens of an image capturing apparatus, and image data is captured. In such a manner, the colors of light entering the image capturing apparatus are corrected by the filter, and the image data can be obtained as a natural image data.

However, to perform image capturing by the above method, it is necessary to measure the color component values by the colorimeter before the image capturing, and attach a filter according to the color component values. Since this complicated work accompanies, the user may miss the optimum moment for a good picture.

In addition, since correction is made by the filter, although the color component value is obtained with high precision, color correction with high precision which reflects the color component value accurately cannot be performed.

In order to solve the problem, it can be considered to provide the image capturing apparatus itself with a sensor for detecting the color component value with high precision. However, such a sensor is expensive, and it makes the circuits of the image capturing apparatus complicated and enlarged.

### SUMMARY OF THE INVENTION

The present invention is directed to a digital camera to be used in conjunction with a portable colorimeter for detecting a color component value.

According to one aspect of the present invention, the digital camera comprises: a colorimeter color component value obtaining part for obtaining a color component value detected by the colorimeter as a colorimeter color component value; an image capturing part for capturing image data of a subject; and a color correcting part for performing a color correcting process on the image data on the basis of the colorimeter color component value.

The color correcting process on the image data is performed on the basis of the colorimeter color component value detected by the colorimeter. Thus, the color correcting process on the image data can be performed with high precision.

In another aspect of the present invention, the digital camera comprises: a colorimeter color component value obtaining part for obtaining a color component value detected by the colorimeter as a colorimeter color component value; an image capturing part for capturing image data of a subject; and a recording part for associating the image data with the colorimeter color component value and recording a resultant.

The image data is associated with the colorimeter color component value and recorded. Consequently, also in the case where the color correcting process is performed on the image data in another external device, the color correcting process can be performed with high precision on the basis of the colorimeter color component value.

In another aspect of the present invention, the digital camera comprises: a colorimeter color component value obtaining part for obtaining a color component value detected by the colorimeter as a colorimeter color component value; a holding part for holding the colorimeter color component value obtained; an image capturing part for capturing image data of a subject; a recording part for recording the image data; and a holding control part for allowing the holding part to hold the colorimeter color component value until the recording part completes recording the image data and deleting the colorimeter color component value from the holding part on completion of the recording of the image data by the recording part.

Since the colorimeter color component value is held until recording of obtained image data is completed, color correction based on the colorimeter color component value can be performed on the image data, as well as the image data can be associated with the colorimeter color component value. In addition, on completion of recording of the image data, the colorimeter color component value is deleted. Therefore, it is possible to prevent color correction form being performed based on the erroneous colorimeter color component value, and prevent the image data from being associated with the erroneous colorimeter color component value in the next image capturing operation. Accordingly a proper colorimeter color component value can be always used.

The present invention is also directed to a portable colorimeter to be used in conjunction with a digital camera.

According to further aspect of the present invention, the colorimeter comprises: a detecting part for detecting a color component value of incident light; a receiving part for receiving an instruction of starting detection of the color component value to be performed by the detecting part; and a transmitting part for transmitting the color component value detected on the basis of the instruction to the digital camera in response to completion of detection of the color component value to be performed by the detecting part.

The color component value is transmitted to the digital camera on completion of detection of the color component value detected on the basis of the instruction. Consequently, operations for transmission of the color component value can be completed by a single operation, to facilitate the operations.

The present invention is also directed to an image processing system including a digital camera to be used in conjunction with a portable colorimeter for detecting a color component value and an image processing apparatus for processing image data obtained by the digital camera.

According to still further aspect of the present invention, the image processing system comprises: a colorimeter color component value obtaining part for obtaining a color component value detected by the colorimeter as a colorimeter color component value; and a color correcting part for performing a color correcting process on the image data on the basis of the colorimeter color component value.

The color correcting process on the image data is performed on the basis of the colorimeter color component value detected by the colorimeter. Thus, the color correcting process on the image data can be performed with high precision.

Accordingly, it is an object of the present invention to provide a technique capable of performing color correction with high precision on a captured image data on the basis of a color component value detected by a portable colorimeter.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a view showing an outline of an image processing system according to a first preferred embodiment;

FIG. 2 is a plan view showing a configuration of a main part of a digital camera;

FIG. 3 is a sectional view showing the configuration of the main part of the digital camera;

FIG. 4 is a rear view showing the configuration of the main part of the digital camera;

FIG. 5 is a block diagram showing the configuration of main components in the digital camera;

FIG. 6 is a diagram for describing a structure of data stored in a memory card;

FIG. 7 is a block diagram showing a main functional configuration of a colorimeter;

FIG. 8 is a flowchart showing an operation at the time of detecting color component values of the colorimeter;

FIG. 9 is a flowchart showing an operation at the time of obtaining color component values of the digital camera;

FIG. 10 is a flowchart showing an image capturing operation of a digital camera 1 of a first preferred embodiment;

FIG. 11 is a view showing an example of warning indication which is outputted to an LCD;

FIG. 12 is a graph for describing a white balance correcting method;

FIG. 13 is a view showing an outline of an image processing system according to a second preferred embodiment;

FIG. 14 is a block diagram showing a configuration of an image processing apparatus;

FIG. 15 is a flowchart showing an image capturing operation of the digital camera 1 of the second preferred embodiment;

FIG. 16 is a diagram for describing a structure of data stored in a memory card; and

FIG. 17 is a block diagram showing a main functional configuration of the image processing apparatus.

### DESCRIPTION OF THE PREFERRED EMBODIMENTS

Hereinafter, preferred embodiments of the present invention will be described in detail with reference to the drawings.

1. First Preferred Embodiment

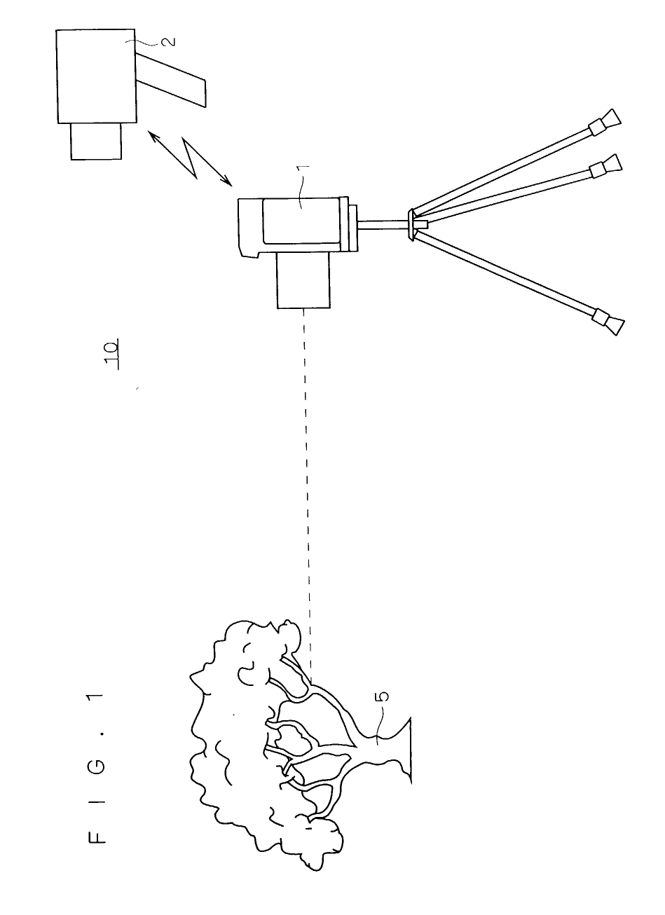

FIG. 1 is a view showing an outline of an image processing system to which a digital camera according to a first preferred embodiment of the present invention is applied. As shown in FIG. 1, an image processing system 10 has a digital camera 1 for capturing an image of a subject 5 and obtaining image data, and a portable colorimeter 2 for detecting color component values (XYZ values conformed with the CIE (International Commission on Illumination) XYZ color notation system) of light entering itself with high precision.

Each of the digital camera 1 and the colorimeter 2 has a radio communications interface, so that various data can be transmitted/received between the digital camera 1 and the colorimeter 2.

As shown in the figure, the digital camera 1 and the colorimeter 2 are used so as to be directed to the same subject 5. The colorimeter 2 obtains a color component value in the direction of the subject 5, and digital camera 1 receives the color component value from the colorimeter 2 and performs white balance correction on image data on the basis of the color component value. The digital camera 1 and the colorimeter 2 can operate in conjunction with each other in the foregoing manner.

1-1. Configuration of Digital Camera

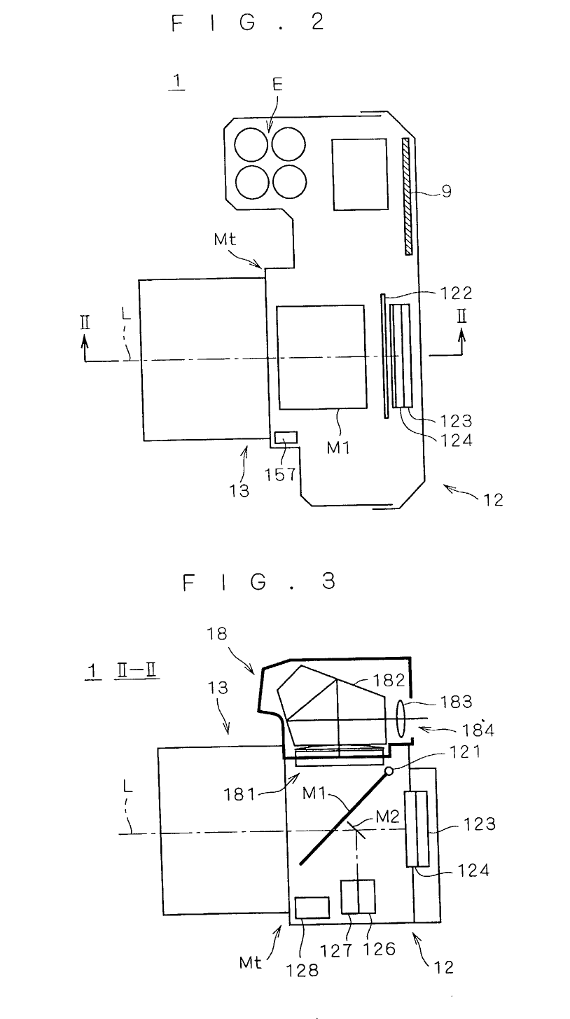

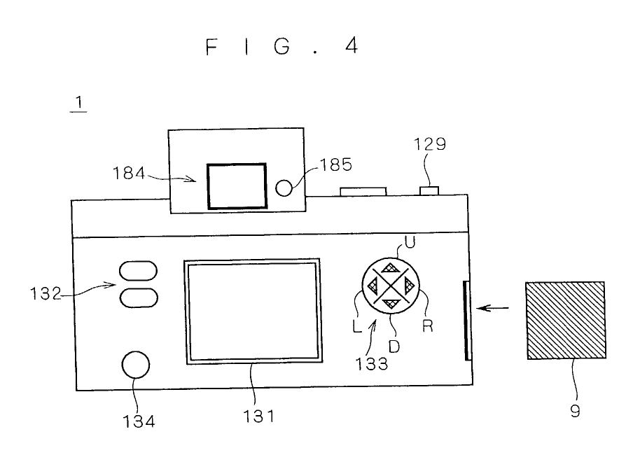

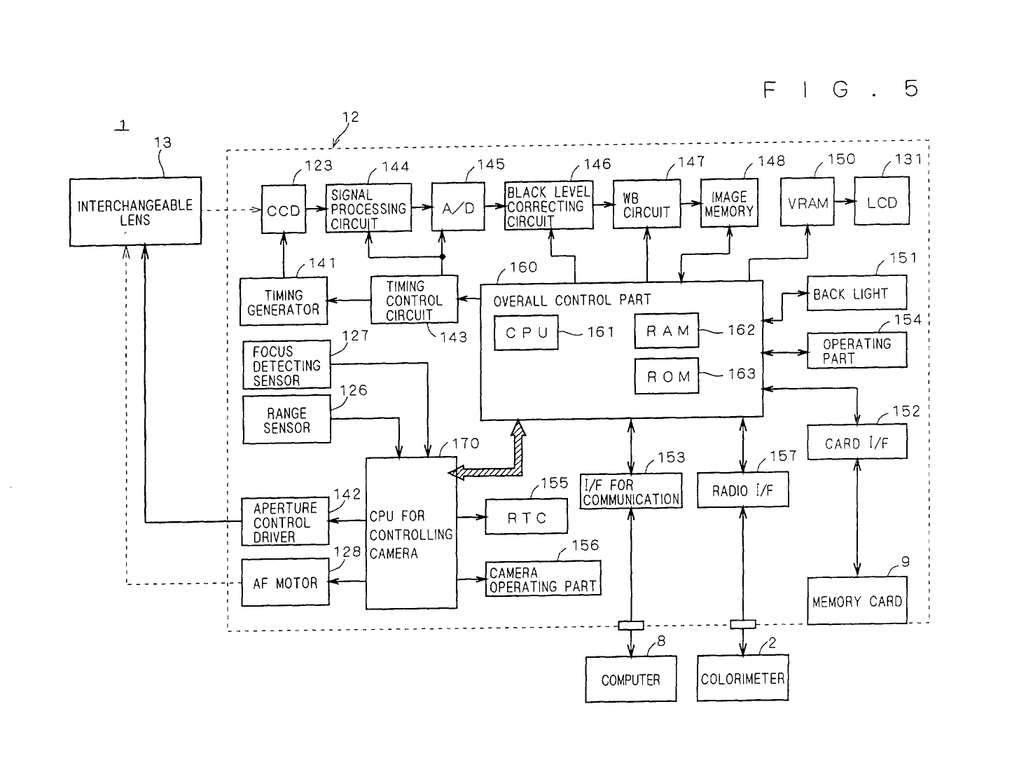

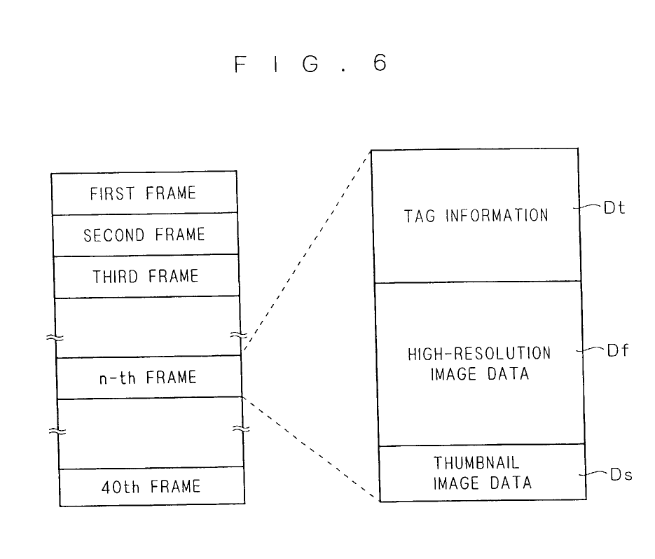

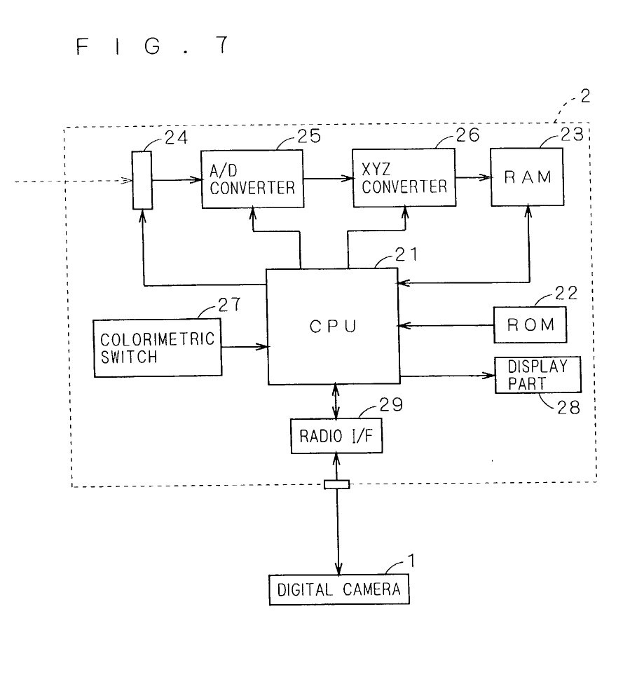

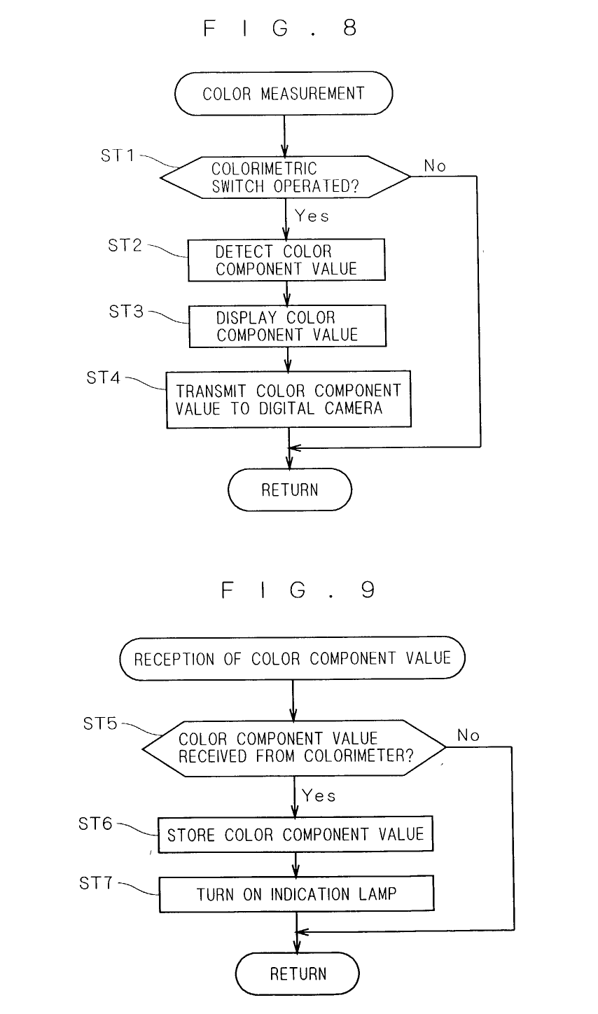

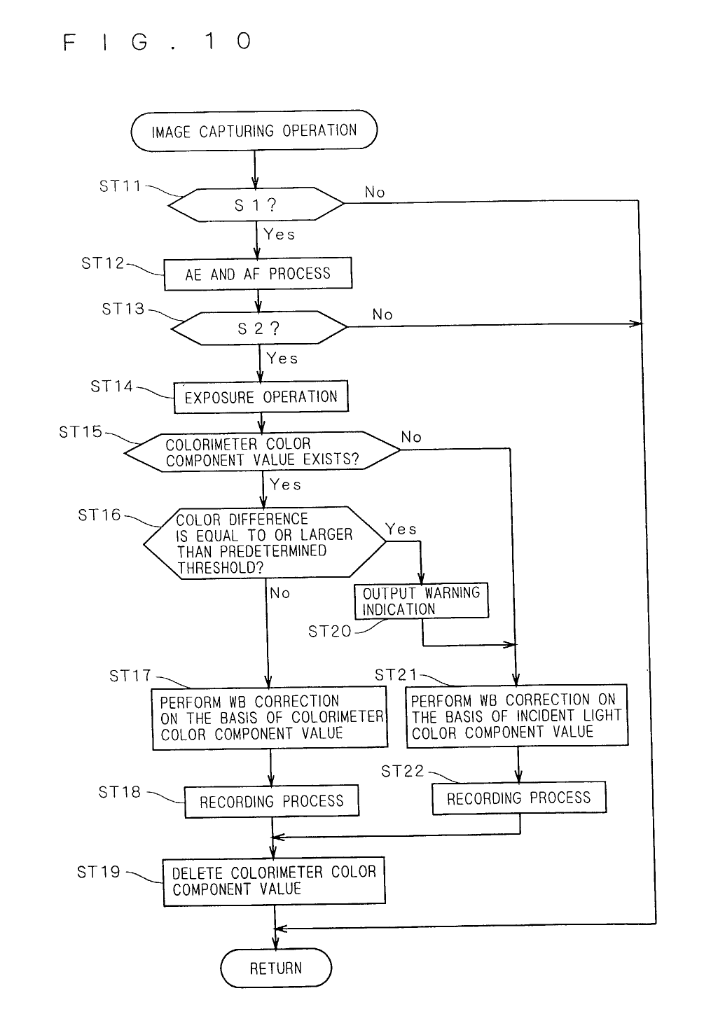

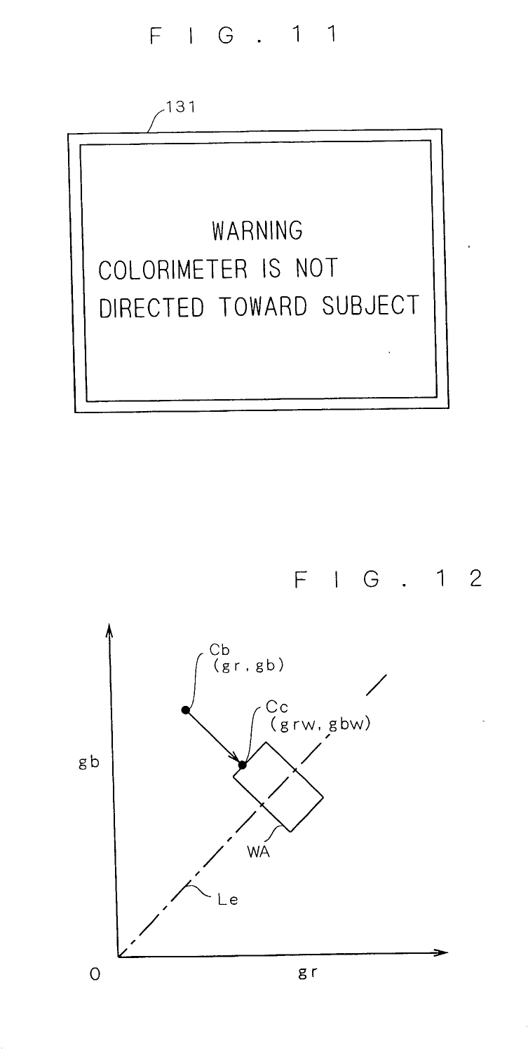

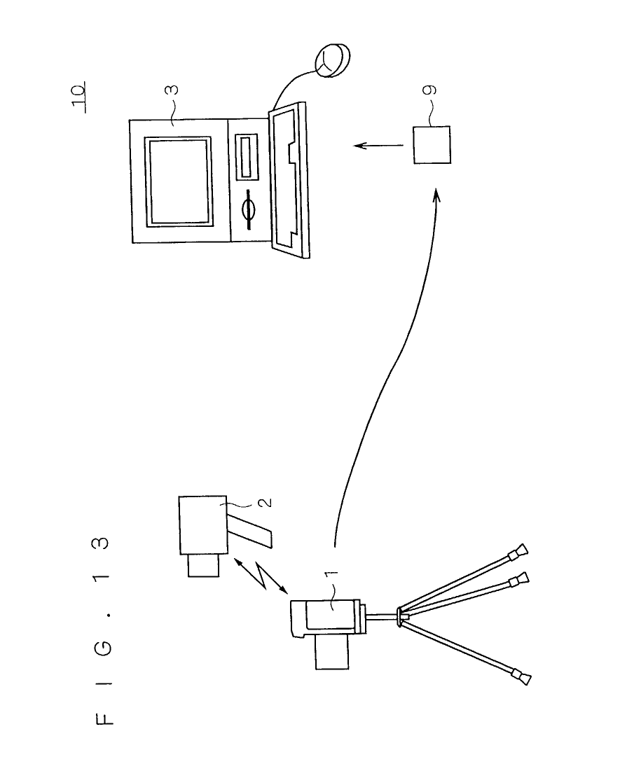

FIGS. 2 to 4 are views showing a configuration of a main part of the digital camera 1, respectively. FIG. 2 is a plan view showing the internal main components, FIG. 3 is a sectional view taken along line II-II of FIG. 2, and FIG. 4 is a rear view of the digital camera 1. The views are not always according to third angle system but are intended to conceptually illustrate the configuration of the main part of the digital camera 1.

The digital camera 1 has a camera body 12 and an interchangeable lens 13 which can be attached/detached to/from a lens mount portion Mt of the camera body 12. For the camera body 12, the same structure as employed for a camera using a film is employed except parts thereof peculiar to a digital camera.

On the rear side in the optical axis direction L of the interchangeable lens 13, a quick return mirror M1 pivoted by a pivot 121 in the upper rear part of the camera body 12 so as to be swingable is disposed. Further, on the rear side in the optical axis direction L of the quick return mirror M1, a focal plane shutter 122 and a color image sensing device 123 are sequentially disposed.

On the front face of the color image sensing device 123, a spatial low pass filter 124 suppressing an influence of aliasing noise at the time of sampling an analog image signal from the color image sensing device 123 is disposed.

In the camera body 12, above the quick return mirror M1, an optical system 18 composing the viewfinder is formed. In the optical system 18, a pentagonal roof prism 182 is provided via a focusing screen 181. An eyepiece 183 is disposed between the prism 182 and a viewfinder window 184. By the quick return mirror M1, prism 182 and eyepiece 183, the optical viewfinder is formed.

A sub mirror M2 is a mirror pivoted on a rear surface of the quick return mirror M1, and an optical image passing through a semitransparent mirror part partially provided for the quick return mirror M1 is sent to a focus detecting sensor 126 and a metering sensor 127 by the sub mirror M2. The focus detecting sensor 126 detects a focus state of the interchangeable lens to cause a focus lens unit housed in the interchangeable lens 13, to achieve focus, and the metering sensor 127 detects luminance of the subject to adjust the exposure amount.

A shutter start button 129 is provided on the top of the camera body 12 and is a two-stage switch capable of detecting a half-pressed state (hereinafter referred to as “S1 state”) and a full-pressed state (hereinafter referred to as “S2 state”) as employed in a camera using a film.

Until the shutter start button 129 is fully pressed by the user, the quick return mirror M1 is in a stationary position where it is inclined at an angle of 45° with respect to the optical axis as shown in FIG. 2 and makes the optical axis L of the interchangeable lens 13 directed toward the focusing screen 181. When the shutter start button 129 is pressed halfway down, the light that traveled through all lens units is detected, thereby driving the focus lens unit in the lens unit to perform focus adjustment. When the shutter start button 129 is fully pressed, the quick return mirror M1 swings upward to almost the horizontal position around the pivot 121 as a center to thereby open the optical path of the interchangeable lens 13.

The camera body 12 has therein an AF motor 128 for driving a focus lens included in the interchangeable lens 13 to the optical axis direction L. Four cells for supplying power to the digital camera 1 and a memory card 9 for recording image data captured and the like can be loaded into the camera body 12.

Above the lens mount portion Mt, a radio communications interface (hereinafter, referred to as “radio I/F”) 157 conformed with the Bluetooth (R) standard is provided. By the radio I/F 157, information such as color component values detected by the colorimeter 2 can be obtained from the colorimeter.

An indication lamp 185 taking the form of an LED or the like is provided on the right side of the viewfinder window 184 in the rear face of the camera body 12. By turn-on or flash of the indication lamp 185, the user can recognize various information from the digital camera 1.

A liquid crystal display (LCD) 131 for displaying captured image data on the basis of an output of the color image sensing device 123 is provided in the center portion of the rear face of the camera body 12. On the left side of the LCD 131, a change-over switch 132 for switching and setting an “image capturing mode”, a “reproduction mode” and the like is provided. The image capturing mode is a mode of taking a picture. The reproduction mode is a mode of reproducing image data recorded on the memory card 9 and displaying the reproduced image on the LCD 131.

A cross key 133 is provided in the right part of the rear face of the digital camera 1, and various operations are performed by buttons U, D, L and R. A power supply switch 134 for turning on/off the power source of the digital camera 1 is provided in the rear face of the camera body 12.

FIG. 5 is a block diagram showing the main configuration in the digital camera 1.

The color image sensing device 123 takes the form of a single-chip color area sensor in which color filters of R (red), G (green) and B (blue) are adhered in a checker pattern on the surface of pixels of an area sensor constructed by a CCD.

The color image sensing device (hereinafter, referred to as “CCD”) 123 photoelectrically converts an optical image of a subject formed by the interchangeable lens 13 into image signals having color components of R, G and B (also properly referred to as signals of a sequence of pixel signals received by pixels, or also referred to as “image data”) and outputs the image data. That is, the CCD 123 obtains the image data of the subject and also RGB values as color component values of incident light.

Color filters of RGB of the CCD 123 do not have a spectral transmittance characteristic conformed with the RGB colorimetric system of CIE but are general color filters. Consequently, RGB values conformed with the RGB colorimetric system of CIE (hereinafter, referred to as “CIE RGB values”) are not obtained as the color component values obtained by the CCD 123 but values similar to the CIE RGB values are obtained.

Exposure control in the digital camera 1 is performed by adjusting the aperture size of an aperture stop in the interchangeable lens 13 by an aperture control driver 142 and an exposure amount of the CCD 123, that is, charge accumulation time of the CCD 123 corresponding to a shutter speed on the basis of the luminance of the subject detected by the metering sensor 127.

A timing generator 141 generates a drive control signal for the CCD 123 on the basis of a reference clock transmitted from a timing control circuit 143. The timing generator 141 generates, for example, timing signals of start and end of integration (start and end of exposure) and clock signals such as read control signals (a horizontal sync signal, a vertical sync signal, a transfer signal and the like) of photosensitive signals of pixels and outputs the signals to the CCD 123.

A signal processing circuit 144 performs a predetermined analog signal process on an image signal (analog signal) outputted from the CCD 123. The signal processing circuit 144 has therein a CDS (Correlated Double Sampling) circuit and an AGC (Auto Gain Control) circuit. Noise of an image signal is reduced by the CDS circuit and the gain of the AGC circuit is adjusted, thereby adjusting the level of an image signal.

An A/D converter 145 converts each pixel signal of the image signal to a digital signal of, for example, 12 bits. The A/D converter 145 converts each pixel signal (analog signal) to a digital signal on the basis of a clock for A/D conversion inputted from the timing control circuit 143.

The timing control circuit 143 generates clocks for the timing generator 141, signal processing circuit 144 and A/D converter 145 and is controlled by a reference clock from an overall control part 160.

A black level correcting circuit 146 corrects the black level of an A/D converted pixel signal (hereinafter, also properly referred to as “pixel value”) to a reference black level.

A WB (White Balance) circuit 147 performs level shifting of the pixel value of each of color components of R, G and B, thereby performing white balance correction on image data. The WB circuit 147 corrects each of pixels values of color components R, G and B on the basis of color component values (RGB values of all of pixels) of image data or color component values (XYZ values) detected by the colorimeter 2. The white balance correction will be described in detail later.

An image memory 148 is a memory for storing pixel data outputted from the WB circuit 147. A VRAM 150 is a buffer memory of image data displayed on the LCD 131. A back light 151 supplies light to the rear face of the LCD 131.

A focus control of the digital camera 1 is performed by driving a focus lens unit included in the interchangeable lens 13 by controlling the AF motor 128 on the basis of the focus state of the interchangeable lens 13 detected by the focus detecting sensor 126. Here, the light that traveled all lens units is to be detected and the focus lens unit in the lens units is to be driven.

In a reproduction mode of the digital camera 1, image data read from the memory card 9 is subjected to a predetermined signal process in the overall control part 160. After that, the resultant data is transferred to the VRAM 150 and reproduced and displayed on the LCD 131.

A card I/F 152 is an interface for writing/reading image data to/from the memory card 9. An I/F 153 for communications is an interface conformed with, for example, the USB standard for external connection to an external computer 8 or the like so as to perform communications.

An operating part 154 is constructed by the change-over switch 132, the cross key 133 and the like.

An RTC 155 is a clock circuit for managing date of image capturing and is driven by not-shown another power source.

A camera operating part 156 is mainly constructed by the shutter start button 129, the power supply switch 134 and the like related to an image capturing operation of the digital camera 1.

The overall control part 160 has a CPU 161, a RAM 162 and a ROM 163 and is organically connected to the components of the digital camera 1 to control the operations of the digital camera 1.

A CPU 170 for controlling the camera is connected to the overall control part 160 so as to perform communications with the overall control part 160, mainly processes an operation by the user to the digital camera 1, and controls the aperture control driver 142 and the AF motor 128.

The overall control part 160 obtains a control program recorded on the memory card 9 or a recording medium such as a CD-ROM read by the computer 8 via the card I/F 152 or the I/F 153 for communications and can store the control program into the ROM 163. The CPU 161 of the overall control part 160 or the CPU 170 for controlling the camera performs a computing process in accordance with the control program, thereby controlling the operation of each of the parts of the digital camera 1.

The overall control part 160 obtains a color component value from the colorimeter 2 via a radio I/F 157 and can store the obtained color component value into the RAM 162.

When image capturing is instructed by the shutter start button 129 in the image capturing mode, the overall control part 160 generates a thumbnail image of image data stored in the image memory 148 after the image capturing instruction was given and an image compressed according to the JPEG system at a set compression ratio and store the images into the memory card 9 together with tag information regarding the captured images (information such as frame number, exposure value, shutter speed, compression ratio, date of image capturing and data of the on/off state of electronic flash at the time of image capturing).

In the memory card 9, as shown in FIG. 6, an image recorded by the digital camera 1 can be compressed and stored. In each frame, tag information Dt, image data Df of high resolution (with, for example, 1600×1200 pixels) compressed in the JPEG format, and image data Ds for displaying a thumbnail (with, for example, 80×60 pixels) are recorded.

1-2. Configuration of Colorimeter

FIG. 7 is a block diagram showing a main functional configuration of the colorimeter 2. The colorimeter 2 is constructed by including a microcomputer as shown in the figure. Concretely, the colorimeter 2 has a CPU 21 for controlling the colorimeter 2, a ROM 22 for storing a control program and the like, and a RAM 23 which is a work area for computation and stores various data. The CPU 21, ROM 22 and RAM 23 are electrically connected to each other.

To the CPU 21, a colorimetric sensor 24, an A/D converter 25 and an XYZ converter 26 are electrically connected and realize a function of detecting color component values of incident light.

The colorimetric sensor 24 is disposed so as to receive incident light and has three light reception components for photoelectrically converting the received incident light to signals (color component values). Color filters respectively adapted to the color components of R, G and B are provided on the light reception faces of the three light reception components respectively. Since the color filter has the spectral transmittance characteristic conformed with the CIE RGB standard colorimetric system, the colorimetric sensor 24 can detect the CIE RGB value as a color component value with high precision.

The A/D converter 25 converts a color component value (analog signal) detected by the colorimetric sensor 24 into, for example, a 12-bit digital signal.

The XYZ converter 26 is a circuit for performing a predetermined matrix computation and converts a color component value of the CIE RGB value as a digital signal into an XYZ value conformed with the CIE XYZ colorimetric system.

To the CPU 21, a colorimetric switch 27 for receiving an instruction to start detection of the color component value from the user, a display part 28 for displaying a detected color component value, and a radio communications interface (hereinafter, referred to as “radio I/F”) 29 conformed with the Bluetooth (R) standard are also electrically connected. By the radio I/F, the colorimeter 2 can transmit the detected color component value to the digital camera 1.

1-3. Colorimetric Operation

An operation of detecting a color component value of incident light performed by the colorimeter 2 will now be described. FIG. 8 is a flowchart showing an operation that the colorimeter 2 detects a color component value and transmits the color component value to the digital camera 1. It is assumed that an address for communications peculiar to each of the colorimeter 2 and the digital camera 1 is already recognized, authentication for connection and the like is already performed, and the colorimeter 2 and the digital camera 1 are in a communicable state.

First, when the colorimetric switch 27 is depressed by the user, the CPU 21 detects the depression and a detection start signal is inputted to the colorimetric sensor 24 (step ST1).

In response to the inputted detection start signal, the colorimetric sensor 24 receives incident light and detects the color component value. The detected color component value is converted into a digital signal by the A/D converter 25 and is further converted by the XYZ converter 26 into an XYZ value. The color component value taking the form of the XYZ value is stored into the RAM 23 (step ST2).

Subsequently, when the color component value is stored in the RAM 23, the CPU 21 detects completion of the detection of the color component value, and displays the color component value of the XYZ value onto the display part 28 (step ST3).

Further, in response to completion of the detection, the color component value stored in the RAM 23 is transmitted to the digital camera 1 as a predetermined device via the radio I/F 29 (step ST4).

Since the color component value is transmitted to the digital camera 1 on completion of detection of the color component value, by a simple operation of depressing the colorimetric switch 27, the operation until transmission of the color component value can be completed.

The operation on the digital camera 1 side to which the color component value is transmitted as described above will now be described. FIG. 9 is a flowchart showing an operation at the time of obtaining the color component value of the digital camera 1.

After authentication for communications and the like is carried out and a state that communications between the digital camera 1 and the colorimeter 2 can be performed is obtained, the digital camera 1 enters a standby mode of waiting for reception of a color component value (step ST5).

In the case where a color component value is received from the colorimeter 2 via the radio I/F 157 in such a state (Yes in step ST5), the color component value (hereinafter, referred to as “colorimeter color component value”) received is stored and held in the RAM 162 by means of the overall control part 160 (step ST6).

Subsequently, when the colorimeter color component value is stored in the RAM 162 normally, the overall control part 160 detects completion of reception and turns on the indication lamp 185 for predetermined time (step ST7).

When the digital camera 1 receives the colorimeter color component value, the user handles the colorimeter 2. By turning on the indication lamp 185 for predetermined time, the user can recognize that the colorimeter color component value is normally received and held by the digital camera 1.

1-4. Image Capturing Operation

An image capturing operation of the digital camera 1 will now be described. FIG. 10 is a flowchart showing an image capturing operation of the digital camera 1.

First, when the shutter start button 129 is pressed halfway down (S1 state) (Yes in step ST1), preparations for capturing an image are made by the CPU 170 for controlling the camera.

Specifically, on the basis of the focus state of the lens unit from the focus detecting sensor 126, the AF motor 128 is controlled so that the position of an image formed by the interchangeable lens 13 coincides with the image capturing face of the CCD 123. Further, based on the luminance of the subject from the metering sensor 127, exposure parameters (aperture value and shutter speed) are set (step ST12).

When the shutter start button 129 is fully pressed (S2 state) (Yes in step ST13), the CCD 123 is exposed for only set exposure time, and image data of the subject is captured as an image signal. The image data outputted from the CCD 23 is subjected to predetermined processes by the signal processing circuit 144, A/D converter 145 and black level correcting circuit 146, and the resultant is inputted to the WB circuit 147 (step ST14).

Subsequently, on the basis of the color component value of image data (the RGB value of all of pixels which is referred to as “incident light color component value” hereinafter) or the colorimeter color component value received from the colorimeter 2, the WB circuit 147 performs white balance correction. When the colorimetric color component value is received, the colorimeter color component value with higher precision is preferentially used.

Consequently, before the white balance correction, whether the colorimeter color component value is received from the colorimeter 2 and stored in the RAM 162 or not is determined by the overall control part 160 (step ST15).

In the case where the colorimeter color component value is not stored (No in step ST15), it is determined that the digital camera 1 operates not in conjunction with the colorimeter 2, and normal white balance correction based on the incident light color component value is performed on image data by the WB circuit 147 (step ST21).

On the other hand, in the case where the colorimeter color component value is stored (Yes in step ST15), it is determined that the digital camera 1 operates in conjunction with the colorimeter 2. Subsequently, the difference between the color indicated by the colorimeter color component value and the color indicated by the incident light color component value is obtained by the overall control part 160 and is compared with a threshold which is preliminarily determined by measurement or the like (step ST16). Since the incident light color component value is an RGB value and the colorimeter color component value is an XYZ value, the color difference cannot be simply calculated. However, it is sufficient to use, as a color difference, the difference between correction factors (which will be described later) for white balance correction derived from both of the color component values or the different of color component values after the colorimetric systems of both of the color component values are set to the same.

Ideally, the colorimeter 2 and the digital camera 1 are directed to the same subject. There is also a case that the colorimeter 2 obtains a colorimeter color component value without being directed toward the subject as an object of the digital camera 1. In such a case, if white balance correction is performed on the basis of the colorimetric color component value thus obtained, there is the possibility that proper color correction is not performed and the picture quality deteriorates. When the colorimeter 2 and the digital camera 1 are directed to the same subject, it can be considered that the difference between the color indicated by the colorimeter color component value and the color indicated by the incident light color component value is relatively small.

It is therefore determined that, when the color different is equal to or larger than a predetermined threshold (Yes in step ST16), the colorimeter 2 and the digital camera 1 are directed to different directions, and a warning is displayed on the LCD 131 as shown in FIG. 11 (step ST20). By the warning, the user can recognize the situation. A method of outputting a warning may be flashing of the indication lamp 185, generation of a predetermined warning sound, or the like.

Subsequently, since it is improper to use the colorimeter color component value, normal white balance correction based on the incident light color component value is performed on image data in the WB circuit 147 (step ST21).

As described above, even there is the possibility that the colorimeter 2 is not directed toward the subject, white balance correction is made on the basis of the incident light color component value, so that color correction can be prevented from being improperly performed. Moreover, the process is continued without discarding image data, so that the user can take a picture without missing a perfect moment for a good picture in any case.

On the other hand, when the color difference is smaller than the predetermined threshold (No in step ST16), it is determined that the colorimeter 2 and the digital camera 1 are directed to the same direction. The colorimeter color component value is read out from the RAM 162, and white balance correction with high precision based on the colorimeter color component value is performed on image data by the WB circuit 147 (step ST17). After that, the image data is stored in the image memory 148, compressed by the overall control part 160, and recorded into the memory card 9 together with the tag information Dt and the thumbnail image Ds (step ST18).

On completion of the recording of the image data, the colorimeter color component value is deleted from the RAM 162 by the overall control part 160 (step ST19). In such a manner, white balance correction based on an erroneous colorimeter color component value can be prevented from being performed in the next image capturing. The white balance correction always based on the latest colorimeter color component value can be performed.

Also in the case where normal white balance correction based on the incident light color component value is performed (step ST21), similarly, image data is stored in the image memory 148, compressed by the overall control part 160, and recorded in the memory card 9 together with the tag information Dt and the thumbnail image Ds (step ST22). If a colorimeter color component value which is determined to be improper and is not used is stored in the RAM 162, the value is deleted from the RAM 162 (step ST19).

In the tag information Dt recorded together with the image data in steps ST18 and ST22, information indicating which of the colorimeter color component value and the incident light color component value is used for the white balance correction is written. By the information, in the case of using the image data later, either white balance correction with high precision or normal white balance correction is performed can be easily determined.

1-5. White Balance Correction

A method of correcting white balance in the operation of the digital camera 1 on the basis of the incident light color component value and that on the basis of the colorimeter color component value will be described. All of computation in the methods described here may be executed by the WB circuit 147 or a part of the computation may be executed by the CPU 161 in the overall control part 160.

In the case of the white balance correction based on the incident light color component values (RGB values of all of pixels) (normal white balance correction), first, each of R, G and B values of all of pixels of obtained image data is totaled, and the calculated total values are set as Rc, Gc and Bc, respectively. For higher efficiency of computation, image data may be divided into a plurality of blocks each having a predetermined area, and total values of only pixels as representatives of each block may be used as Rc, Gc and Bc, or total values of pixels reduced at predetermined intervals may be used as Rc, Gc and Bc.

The proportion (to be accurate, inverse) gr of Rc in Gc and the proportion gb of Bc in Gc are calculated as follows.

gr=Gc/Rc

gb=Gc/Bc

The calculated gr and gb are plotted as a pre-correction point Cb (gr, gb) to a graph having a horizontal axis gr and a vertical axis gb as shown in FIG. 12. The graph of FIG. 12 shows a color balance of the whole image data obtained. In the example of FIG. 12, since the pre-correction point Cb is positioned on the left upper side of a line Le (line on which gb=gr), it is understood that image data is leaned to the R component (reddish).

A point in a predetermined area WA in a shortest distance from the pre-correction point Cb (gr, gb) is set as a post-correction point Cc (grw, gbw). The area WA is an area including (gr, gb) of image data of which colors are balanced and is preliminarily set by measurement or the like as an area showing the target color balance after white balance correction. When the pre-correction point Cb is included in the area WA, the colors are balanced, so that the pre-correction point Cb is used as the post-correction point Cc.

The white balance correction corresponds to movement of the pre-correction point Cb (gr, gb) to the post-correction point Cc (grw, gbw). Consequently, coefficients Krc and Kbc for moving the pre-correction point Cb (gr, gb) to the post-correction point Cc (grw, gbw) are calculated as follows.

Krc=grw/gr

Kbc=gbw/gb

Each of the coefficients Krc and Kbc is a value indicative of the relative relation between the target color balance after white balance correction and the color balance of the whole image data obtained, and is a correction factor for the white balance correction.

The calculated correction factors Krc and Kbc are reflected in pixel values of image data. The computation is performed by the following equations when the pixel values before correction are R, G and B, and pixel values after white balance correction are Rw, Gw, and Bw.

Rw=R/Krc

Gw=G

Bw=B/Kbc

By executing the computation on all of pixels in the image data, white balance correction based on the incident light color component value is performed on the image data.

On the other hand, in the case of correction based on the colorimeter color component values (XYZ values) with high precision obtained from the colorimeter 2, first, the XYZ values are converted to CIE RGB values by predetermined matrix computation. The R, G and B values after conversion are set as Rs, Gs and Bs, respectively.

Subsequently, the coefficients Krs and Kbs are calculated by using Rs, Gs and Bs as follows.

Krs=Rs/Gs

Kbs=Bs/Gs

The coefficients Krs and Kbs indicate unbalance of the colors of the colorimeter color component values and can be used as correction factors for white balance correction.

Consequently, in a manner similar to the above, the correction factors Krs and Kbs are reflected in the pixel values of the image data by the following equations.

Rw=R/Krs

Gw=G

Bw=B/Kbs

By executing the computation on all of pixels in the image data, white balance correction based on the colorimeter color component value of the image data is performed. As the correction is performed on the basis of the colorimeter color component value of high precision, the white balance correction is also performed with high precision.

According to the first preferred embodiment as described above, in the digital camera 1, a colorimeter color component value detected by the portable colorimeter 2 is obtained and the white balance correction is performed on image data on the basis of the colorimeter color component value. Thus, the white balance correction can be performed on image data with high precision.

In the case where the digital camera 1 operates not in conjunction with the colorimeter 2 or in the case where a colorimeter color component value detected by the colorimeter 2 is not a reliable value, the digital camera 1 performs white balance correction on the basis of the incident light component value. Therefore, in any case, proper white balance correction can be performed.

On completion of recording of image data, the digital camera 1 deletes the colorimeter color component value. Consequently, white balance correction based on an erroneous colorimeter color component value can be prevented from being performed at the next image capturing, and white balance correction based on a high-precision colorimeter color component value can be always properly performed.

2. Second Preferred Embodiment

A second preferred embodiment of the present invention will now be described. In the first preferred embodiment, white balance correction based on the colorimeter color component value is performed in the digital camera 1. In the second preferred embodiment, white balance correction based on the colorimeter color component value is performed by an external image processing apparatus.

2-1. Configuration of Image Processing System

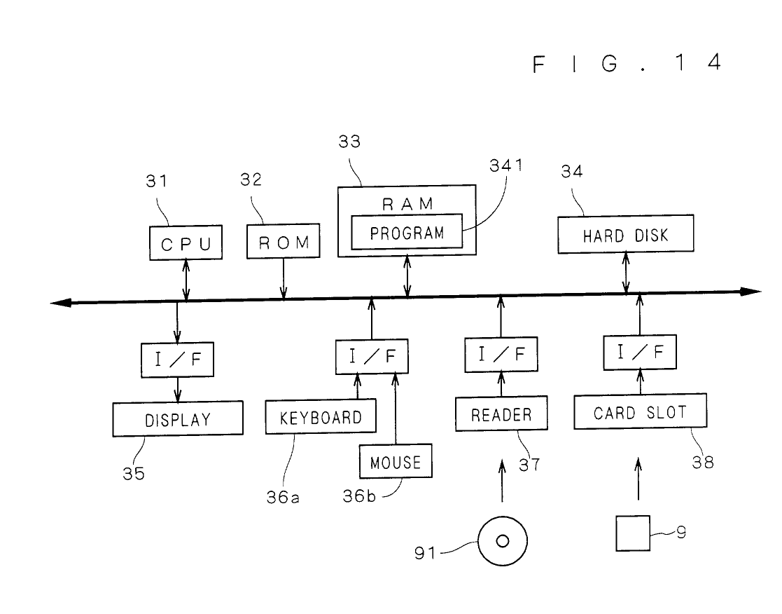

FIG. 13 is a view showing the outline of the image processing system 10 according to the second preferred embodiment of the present invention. As shown in FIG. 13, the image processing system 10 of the preferred embodiment has: the colorimeter 2 for detecting a color component value with high precision; the digital camera 1 for associating the colorimeter color component value obtained from the colorimeter 2 with image data and recording the data into the memory card 9; and an image processing apparatus 3 for obtaining the image data via the memory card 9 and performing an image process such as white balance correction.

The configuration of the digital camera 1 of the second preferred embodiment is substantially the same as that of the digital camera 1 of the first preferred embodiment shown in FIGS. 2 to 5. In the ROM 163 of the overall control part 160 in the digital camera 1, an ICC (International Color Consortium) profile for color matching (hereinafter, referred to as “camera profile”) as color characteristic information indicative of a characteristic peculiar to the digital camera 1 is prestored. The configuration of the colorimeter 2 of the second preferred embodiment is similar to that of the colorimeter 2 of the first preferred embodiment shown in FIG. 7.

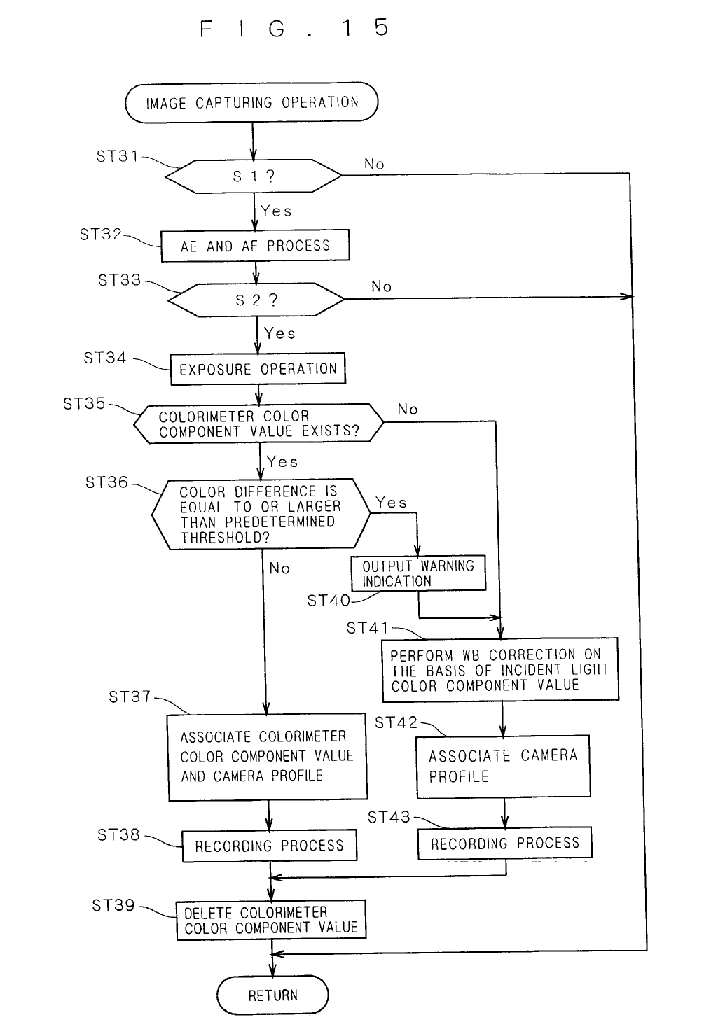

FIG. 14 is a block diagram showing the configuration of the image processing apparatus 3. The image processing apparatus 3 has a configuration of a general computer system in which a CPU 31, a ROM 32 and a RAM 33 are connected to a bus line. To the bus line, a display 35, a keyboard 36a and a mouse 36b for receiving inputs from the user, a hard disk 34 for storing data, a program and the like, a reader 37 for receiving/transmitting information from/to a recording disk 91 (optical disk, magnetic disk, magneto-optical disk or the like), and a card slot 38 for receiving/transmitting information from/to the memory card 9 are also connected each properly via an interface (I/F) or the like.

The RAM 33, hard disk 34, reader 37 and card slot 38 can transmit/receive data to/from each other. Under control of the CPU 31, various information and image data stored in the memory card 9 can be displayed on the display 35.

A program 341 shown in FIG. 14 is read from the recording disk 91, stored in the hard disk 34 via the reader 37, and transferred from the hard disk 34 to the RAM 33. The program 341 can be executed by the CPU 31. When the program 341 is executed by the CPU 31, various functions of the image processing apparatus are realized. When the image processing apparatus 3 has a computer communications part, the program 341 may be downloaded from a predetermined server via a communications line and stored into the hard disk 34.

2-2. Operations of Colorimeter and Digital Camera

Operations at the time of detecting a color component value of the colorimeter 2 of the second preferred embodiment are similar to those shown in FIG. 8, and operations at the time of obtaining a color component value from the colorimeter 2 of the digital camera 1 are similar to those shown in FIG. 9.

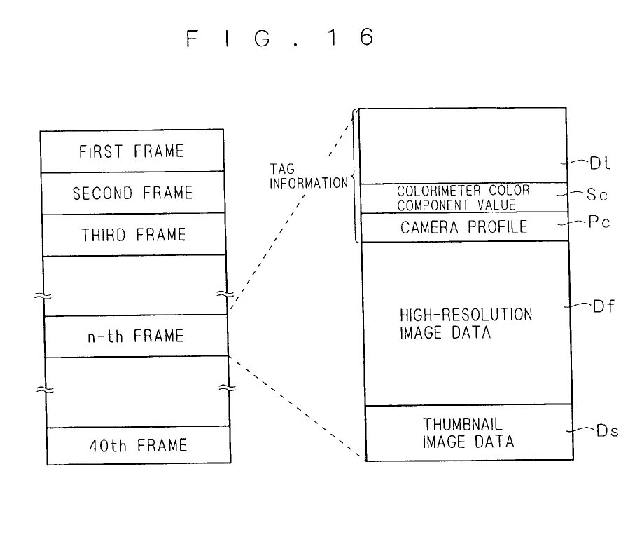

FIG. 15 is a flowchart showing an image capturing operation of the digital camera 1 of the preferred embodiment. Since the flow of the image capturing operation is similar to that of the image capturing operation of the digital camera 1 of the first preferred embodiment shown in FIG. 10, different points will be mainly described.

The operations in steps ST31 to ST34 are similar to those in steps ST11 to ST14 in FIG. 10. Image data obtained by the operations is subjected to a predetermined process and the resultant is inputted to the WB circuit 147.

Subsequently, when the colorimeter color component value is not stored in the RAM 162 (No in step ST35), in a manner similar to the first preferred embodiment, normal white balance correction based on the incident light component value is performed on the image data in the WB circuit 147 (step ST41).

Although the colorimeter color component value is stored in the RAM 162 (Yes in step ST35), when the difference between the color indicated by the colorimeter color component value and the color indicated by the incident light color component value is equal to or larger than a predetermined threshold (Yes in step ST36), in a manner similar to the first preferred embodiment, a warning is displayed on the LCD 131 (step ST40), and normal white balance correction based on the incident light color component value is performed on the image data in the WB circuit 147 (step ST41).

The image data subjected to normal white balance correction is stored in the image memory 148, associated with a camera profile by the overall control part 160 (step ST42), compressed, and recorded with the tag information Dt and the thumbnail image Ds into the memory card 9 (step ST43). The camera profile is recorded as a part of the tag information Dt. In the case where the colorimeter color component value which is determined to be improper is stored in the RAM 162, the value is deleted from the RAM 162 (step ST39).

On the other hand, when the colorimeter color component value is stored in the RAM 162 (Yes in step ST35) and the difference between the color indicated by the colorimeter color component value and the color indicated by the incident light color component value is smaller than the predetermined threshold (No in step ST36), that is, when it is determined that the digital camera 1 properly operates in conjunction with the colorimeter 2, image data is stored as it is into the image memory 148 without being subjected to white balance correction in the WB circuit 147.

The image data is associated with the colorimeter color component value and the camera profile by the overall control part 160 (step ST37), compressed, and recorded with the tag information Dt and the thumbnail image Ds into the memory card 9 (step ST38).

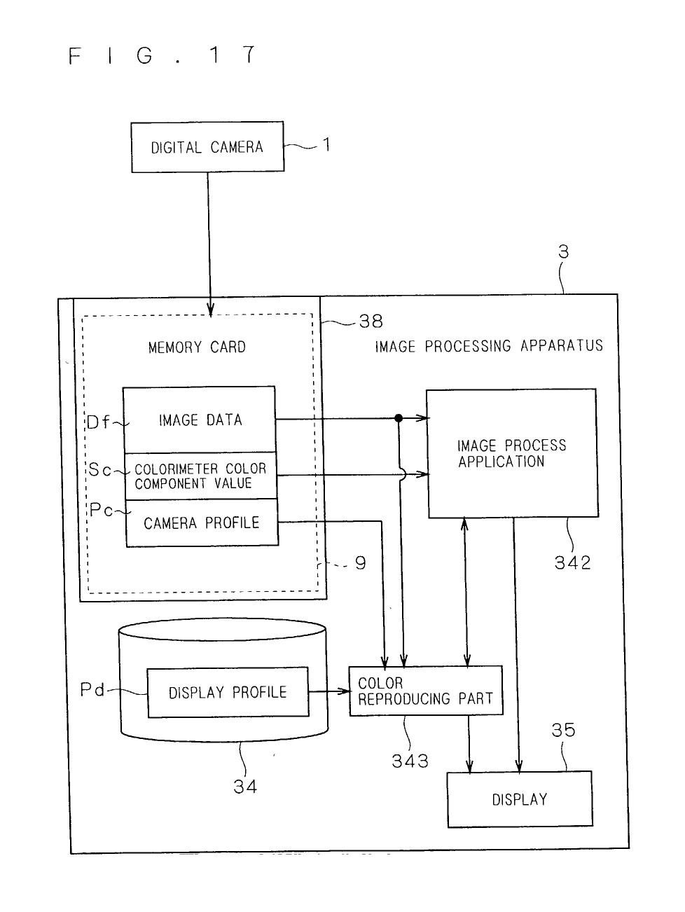

The colorimeter color component value and the camera profile become, as shown in FIG. 16, a part of the tag information Dt. The image data Df is recorded while being associated with the colorimeter color component value Sc and the camera profile Pc.

Since the digital camera 1 records the image data associated with the colorimeter color component value and the camera profile without performing the white balance correction on the image data, an image process such as white balance correction according to the preference of the user can be performed later based on the colorimeter color component value, the camera profile and the like in the image processing apparatus 3.

After recording of the image data is completed, the colorimeter color component value is deleted from the RAM 162 by the overall control part 160 (step ST39). In such a manner, an erroneous colorimeter color component value can be prevented from being associated at the time of the next image capturing, and the colorimeter color component value which is always the latest can be associated.

2-3. Process in Image Processing Apparatus

A process performed by the image processing apparatus 3 on the image data Df associated with the colorimeter color component value Sc and the camera profile Pc as described above will now be described.

FIG. 17 is a block diagram showing the main functional configuration of the image processing apparatus 3. In FIG. 17, an image processing application 342 and a color reproducing part 343 have the function realized when the CPU 31 in the image processing apparatus 3 executes the program 341. As shown in FIG. 17, an ICC profile Pd for color matching as color characteristic information indicative of the characteristic peculiar to the display 35 (hereinafter, referred to as “display profile”) is prestored in the hard disk 34.

The image data Df captured by the digital camera 1 and the colorimeter color component value Sc and the camera profile Pc associated with the image data Df are inputted to the image processing apparatus 3 via the memory card 9. That is, by loading the memory card 9 into the card slot 38, the image processing apparatus 3 can handle the image data Df, colorimeter color component value Sc and camera profile Pc stored in the memory card 9.

The image processing application 342 has the function of performing various image processes on the image data Df. One of the functions is to perform white balance correction on the image data Df by using the colorimeter color component value Sc associated with the image data Df. As a method of correcting the white balance, the above-described method of performing white balance correction based on the colorimeter color component value can be applied. Also in the image processing apparatus 3, the white balance correction with high precision can be performed.

The color reproducing part 343 performs a color reproducing process for properly reproducing colors of the image data Df. Concretely, on the basis of the camera profile Pc indicative of the characteristic of the digital camera 1 as an input-side device, the image data Df is converted into a colorimetric system (Lab colorimetric system or the like) which does not depend on a device. Further, based on the display profile Pd indicative of the characteristics of the display 35 as an output-side device, the converted image data Df is subjected to adjustment of a color reproduction range (gamut) and converted into a colorimeter system which can be output by the display 35. By such processes, color matching is carried out, and colors of the image data Df obtained by the digital camera 1 are properly reproduced on the display 35.

The functions of the image processing application 342 and the color reproducing part 343 can be selectively used in accordance with preference of the user.

For example, after performing white balance correction based on the colorimeter color component value Sc on the image data Df by the image processing application 342, and the color reproducing process by the color reproducing part 343, the resultant image can be displayed on the display 35. It is also possible to perform the white balance correction based on the colorimeter color component value Sc by the image processing application 342 on the image data Df and display the resultant on the display 35. Alternately, it is also possible to perform the color reproducing process by the color reproducing part 343 without conducting white balance correction, and display the resultant on the display 35.

In the case where either the white balance correction or the color reproducing process is performed on the image data Df, since the colorimeter color component value Sc and the camera profile Pc are associated with the image data Df, the colorimeter color component value Sc or camera profile Pc can be promptly used, so that it is very convenient.

According to the second preferred embodiment as described above, in the image processing system 10, the digital camera 1 records the image data so as to be associated with the colorimeter color component value. Consequently, even in the case of performing the white balance correction on the image data by the image processing apparatus 3, white balance correction can be performed with high precision.

Since the digital camera 1 records the image data associated with the camera profile, color matching can be performed in the image processing apparatus 3, and colors of the image data can be properly reproduced.

3. Modifications

Although the foregoing preferred embodiments have been described by taking the case, as an example, that the digital camera 1 and the colorimeter 2 transfer the colorimeter color component value by radio communications conformed with the Bluetooth (R) standard, the colorimeter color component value may be transferred by radio communications conformed with any standard. Alternately, the colorimeter color component value may be transmitted by wired communications using a connection cable or the like.

The digital camera 1 of the preferred embodiment may switch between the image capturing operation in the first preferred embodiment and that in the second preferred embodiment in accordance with a setting. Specifically, the mode of performing the white balance correction on the basis of the colorimeter color component value on image data and a mode of recording image data which is associated with the colorimeter color component value may be switched according to a setting.

The present invention is not limited to the methods of the white balance correction in the preferred embodiments but any method may be employed such as a method of preparing a correction table according to color temperature of illumination light and correcting each pixel value with reference to the correction table according to the color temperature detected. In the case of using color temperature, the colorimeter 2 obtains color temperature as a color component value. Even in the case of using any method as the white balance correcting method, by using the color component value from the colorimeter 2, white balance correction can be performed with higher precision.

In the foregoing preferred embodiments, the ICC profile is used as color characteristic information indicative of the characteristic peculiar to the digital camera. However, information of any data format may be used.

A part of the function realized when computation is performed by the CPU 161 of the overall control part 160 in the digital camera 1 in accordance with a control program in the preferred embodiment may be realized by a dedicated electric circuit. Particularly, by constructing a part which repeats computation by a logic circuit, high-speed computation can be realized.

While the invention has been shown and described in detail, the foregoing description is in all aspects illustrative and not restrictive. It is therefore understood that numerous modifications and variations can be devised without departing from the scope of the invention.

What is claimed is:

1. A digital camera to be used in conjunction with a portable colorimeter for detecting a color component value, said digital camera comprising:
a colorimeter color component value obtaining part for obtaining a color component value detected by said colorimeter as a colorimeter color component value;
an image capturing part for capturing image data of a subject; and
a color correcting part for performing a color correcting process on said image data on the basis of said colorimeter color component value.

2. The digital camera according to claim 1, further comprising:
a determining part for determining whether said digital camera operates in conjunction with said colorimeter or not, wherein
said color correcting part varies said color correcting process according to whether said determining part determines or not that said digital camera operates in conjunction with said colorimeter.

3. The digital camera according to claim 2, further comprising:
an incident light color component value obtaining part for obtaining a color component value of incident light as an incident light color component value, wherein
when said determining part determines that said digital camera operates in conjunction with said colorimeter, said color correcting part performs said color correcting process on the basis of said colorimeter color component value, and
when said determining part determines that said digital camera operates not in conjunction with said colorimeter, said color correcting part performs said color correcting process on the basis of said incident light color component value.

4. The digital camera according to claim 1, further comprising:
an incident light color component value obtaining part for obtaining a color component value of incident light as an incident light color component value; and
a warning output part for outputting a warning when a difference between a value derived from said colorimeter color component value and a value derived from said incident light color component value, becomes equal to or larger than a predetermined threshold.

5. The digital camera according to claim 2, further comprising:
an incident light color component value obtaining part for obtaining a color component value of incident light as an incident light color component value, wherein
when a difference between a value derived from said colorimeter color component value and a value derived from said incident light color component value is smaller than a predetermined threshold, said color correcting part performs said color correcting process on the basis of said colorimeter color component value, and
when the difference between the value derived from said colorimeter color component value and the value derived from said incident light color component value is equal to or larger than said predetermined threshold, said color correcting part performs said color correcting process on the basis of said incident light color component value.

6. A digital camera to be used in conjunction with a portable colorimeter for detecting a color component value, said digital camera comprising:
a colorimeter color component value obtaining part for obtaining a color component value detected by said colorimeter as a colorimeter color component value;
an image capturing part for capturing image data of a subject; and
a recording part for associating said image data with said colorimeter color component value and recording a resultant.

7. The digital camera according to claim 6, further comprising:
a color correcting part for performing a color correcting process on said image data; and
a determining part for determining whether said digital camera operates in conjunction with said colorimeter or not, wherein
when said determining part determines that said digital camera operates in conjunction with said colorimeter, said color correcting part does not perform said color correcting process.

8. The digital camera according to claim 6, wherein
said recording part further associates said image data with color characteristic information indicative of a characteristic peculiar to the digital camera and records a resultant.

9. The digital camera according to claim 6, further comprising:
an incident light color component value obtaining part for obtaining a color component value of incident light as an incident light color component value; and
a warning output part for outputting a warning when a difference between a value derived from said colorimeter color component value and a value derived from said incident light color component value, becomes equal to or larger than a predetermined threshold.

10. A digital camera to be used in conjunction with a portable colorimeter for detecting a color component value, said digital camera comprising:
a colorimeter color component value obtaining part for obtaining a color component value detected by said colorimeter as a colorimeter color component value;
a holding part for holding said colorimeter color component value obtained;
an image capturing part for capturing image data of a subject;
a recording part for recording said image data; and
a holding control part for allowing said holding part to hold said colorimeter color component value until said recording part completes recording said image, data and deleting said colorimeter color component value from said holding part on completion of the recording of said image data by said recording part.

11. The digital camera according to claim 10, further comprising:
a color correcting part for performing a color correcting process on said image data on the basis of said colorimeter color component value.

12. The digital camera according to claim 10, wherein
said recording part associates said image data with said colorimeter color component value and recording a resultant.
